(19) United States
(12) Patent Application Publication
(10) Pub. No.: US 2022/0103251 A1
(43) Pub. Date: Mar. 31, 2022

(54) METHODS AND DEVICES FOR OPTICAL DATA COMMUNICATION WITH INTEGRATED DATA-TRANSPARENT OTDR

(71) Applicant: ULTRA COMMUNICATIONS, INC., Vista, CA (US)

(72) Inventors: Richard J. WEISS, San Diego, CA (US); Charles B. KUZNIA, Encinitas, CA (US)

(21) Appl. No.: 17/036,883

(22) Filed: Sep. 29, 2020

(51) Int. Cl. H04B 10/071; H04B 10/079

(52) U.S. Cl. CPC H04B 10/071; H04B 10/0791

(57) ABSTRACT

Methods and devices for optical data communication with integrated OTDR capability are described. Unused ports of a multi-fiber connector that is used for coupling between two communication modules are used for OTDR measurement that is transparent to the data communication. Results of the OTDR measurement can be used to infer quality/performance of links used for the data communication. According to one aspect, coupling of a communication module with integrated OTDR capability to a respective multi-fiber connector is via individual optical fibers. According to another aspect, coupling of the communication module with integrated OTDR capability to the respective multi-fiber connector is according to a stacked configuration using an optical guide module arranged between the communication module and the respective multi-fiber connector.

### TECHNICAL FIELD

The present teachings relate to the field of communication systems and networks that use fiber optic links. More particularly, the present teachings relate to methods and systems for optical time domain reflectometry (OTDR) of the fiber optic links used in such communication systems and networks while remaining transparent to the data being communicated.

### BACKGROUND

Fiber optics offer high data rate and electromagnetic interference immunity for data communication systems. While fiber optics were originally utilized for long distance links, fiber optics are now becoming prevalent in applications with short distance links, for example within data centers and fiber-to-the-home (FTTH) networks wherein high running duty cycles, high data integrity, and secure data are prerequisites. In addition, fiber optics may be used in applications that may operate in harsh environments, such as, for example, in communication systems and networks used in aircrafts, helicopters, unmanned vehicles, ship-boards, space-crafts and missiles, wherein the fiber optic links may be subjected to severe shock, vibration, exposure to liquid contaminates, and wide temperature ranges (such a −55 C to 125 C).

Such operating requirements may in turn cause stress and damage to hardware components of the communication systems, including to the fiber optic links, and accordingly necessitate maintenance and troubleshooting. However, the available diagnostic and analysis tools for troubleshooting of faults in the fiber optic links are often expensive, physically large and heavy, require system downtime and skilled operators/analysts, making their usage for efficient link analysis and fault diagnosis impractical. Furthermore, there are no integrated tools available today that may allow detection of tampering and/or changes to the fiber optic links that may be necessary to guarantee link performance and data security of the communication system.

OTDR is a method that can be used for measuring the performance of such fiber optic links, including location of issues/faults that may affect the performance. Accordingly, integration of OTDR capability into such communication systems, such as for example, within (optical) communication modules used for the data communication may be highly desirable. However, such integration may need to take into consideration various factors that may impact the communication system, such as, for example, integrity and criticality of the data being communicated as well as potential requirements and associated cost for upgrades of the data communication links and/or modules, to support, for example, new communication schemes and/or speeds.

In view of the above, the present teachings disclose methods and devices for optical data communication with integrated OTDR capability that is transparent to the data being communicated. Accordingly, the OTDR capability may be integrated within an optical communication system for diagnosing of the communication links while not affecting the data being communicated over such links.

### SUMMARY

According to a first aspect of the present disclosure, an optical data communication arrangement is presented, comprising: a multi-fiber connector comprising at least one data communication port and at least one unused port that is separate from the data communication port; at least one transmitter or receiver optically coupled to the at least one data communication port; and an optical time domain reflectometer (OTDR) optically coupled to the at least one unused port.

According to a second aspect of the present disclosure, an optical data communication system is presented, comprising: a first multi-fiber connector comprising a plurality of data communication ports and at least one unused port that is separate from said data communication ports; one or more transmitters optically coupled to respective one or more ports of the plurality of data communication ports of the first multi-fiber connector; and an optical time domain reflectometer (OTDR) optically coupled to the at least one unused port of the first multi-fiber connector.

According to a third aspect of the present disclosure, a method for detecting a fault in a data communication optical path of a fiber optic network is presented, the method comprising: optically coupling one or more communication ports of a multi-fiber connector to respective one or more transmitters; optically coupling an optical time domain reflectometer (OTDR) to an unused port of the multi-fiber connector; based on the coupling, providing an optical path coupled to the OTDR that follows one or more data communication optical paths coupled to the respective one or more transmitters; and performing an OTDR measurement on the optical path coupled to the OTDR; and based on the performing, using a detected fault as an indication of a fault in the one or more data communication optical paths.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows an exemplary block diagram of a fiber optic network wherein optical fibers form fiber optic links between ports of the network.

FIG. 1B shows a fiber optic link between two ports of the fiber optic network of FIG. 1A, wherein the fiber optic link comprises a transmit path formed by a single optical fiber segment connected to a transmitter module at a transmit port of the two ports.

FIG. 1C shows another fiber optic link between two ports of the fiber optic network of FIG. 1A, wherein the fiber optic link comprises a transmit path formed by at least two optical fiber segments connected to a transmitter module at a transmit port of the two ports.

FIG. 1D shows two fiber optic links between two ports of the fiber optic network of FIG. 1A, wherein the fiber optic links are each formed by one or more optical fiber segments connected to communication modules.

FIG. 1E shows a fiber optic link between two ports of the fiber optic network of FIG. 1A, wherein the fiber optic link comprises a bidirectional transmit and receive path formed by one or more optical fiber segments connected to communication modules at the two ports.

FIG. 2A shows a simplified block diagram of a network component of the fiber optic network of FIG. 1A comprising an embedded communication module.

FIG. 2B shows another simplified block diagram of a network component of the fiber optic network of FIG. 1A comprising external plug-in communication modules.

FIG. 2C shows yet another simplified block diagram of a network component of the fiber optic network of FIG. 1A comprising external plug-in communication modules.

FIG. 3A shows a simplified block diagram of a connection between two communication modules via respective multi-fiber connectors.

FIG. 3B shows optical ports assignments for three exemplary multi-fiber connectors.

FIG. 4A shows a simplified block diagram of a transmitter module with an integrated optical time domain reflectometer (OTDR) that can be integrated in a chip, such as, for example, an ASIC.

FIG. 4B shows a schematic of another exemplary implementation of an optical time domain reflectometer (OTDR).

FIG. 5A shows a simplified block diagram of a network component of the fiber optic network of FIG. 1A comprising an integrated OTDR.

FIG. 5B shows a simplified block diagram of a network component of the fiber optic network of FIG. 1A, such as the network component of FIGS. 2A and 2B, comprising the OTDR of FIG. 4A integrated with a communication module.

FIG. 5C shows a simplified block diagram according to an embodiment of the present disclosure of a network component of the fiber optic network of FIG. 1A, such as the network component of FIGS. 2A and 2B, comprising an OTDR integrated with a communication module but transparent to communication data.

FIG. 5D shows a simplified block diagram of a connection according to an embodiment of the present disclosure between two communication modules via respective multi-fiber connectors.

FIG. 6 shows a simplified block diagram of a stacked connection arrangement according to an embodiment of the present disclosure of a communication module comprising an integrated OTDR to a multi-fiber connector via an optical guide module.

FIG. 7 is a process chart showing a method according to an embodiment of the present disclosure for detecting a fault in a data communication optical path of a fiber optic network.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein.

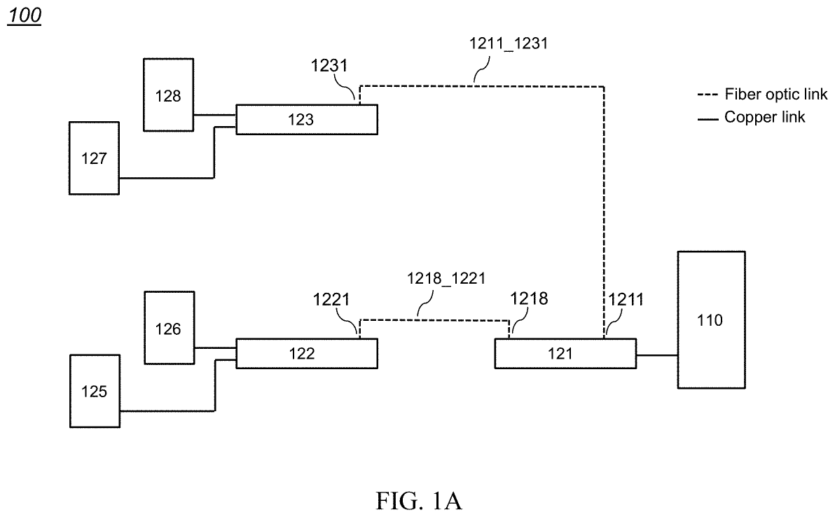

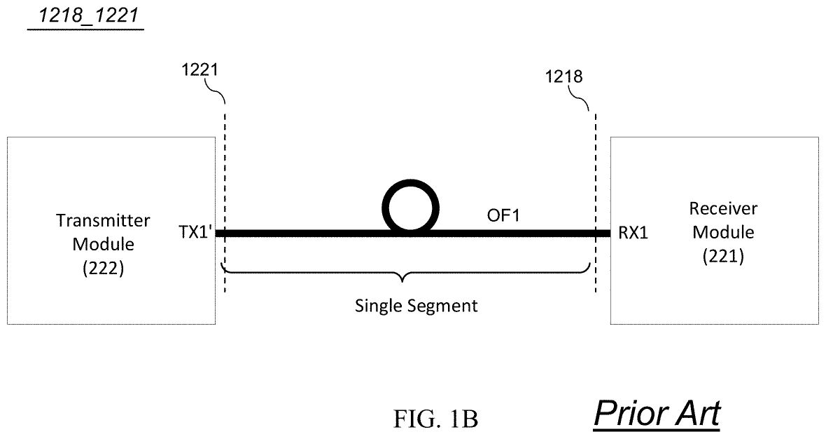

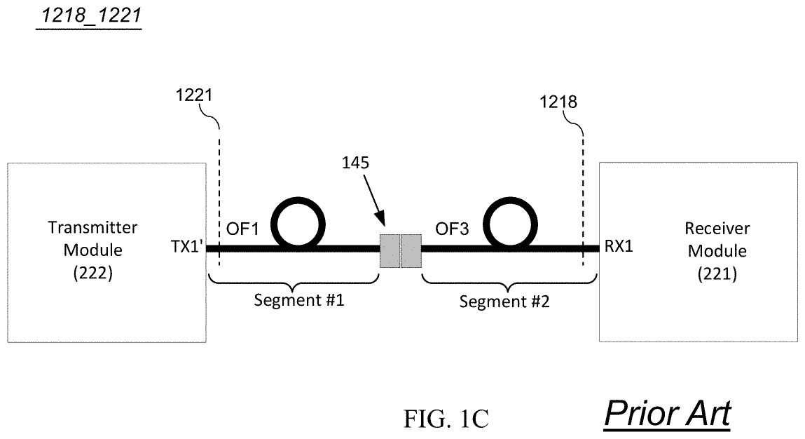

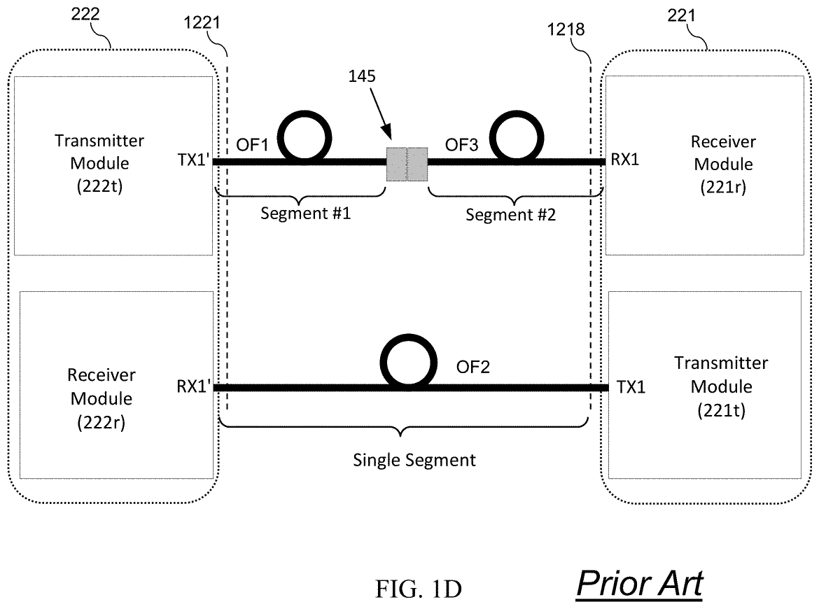

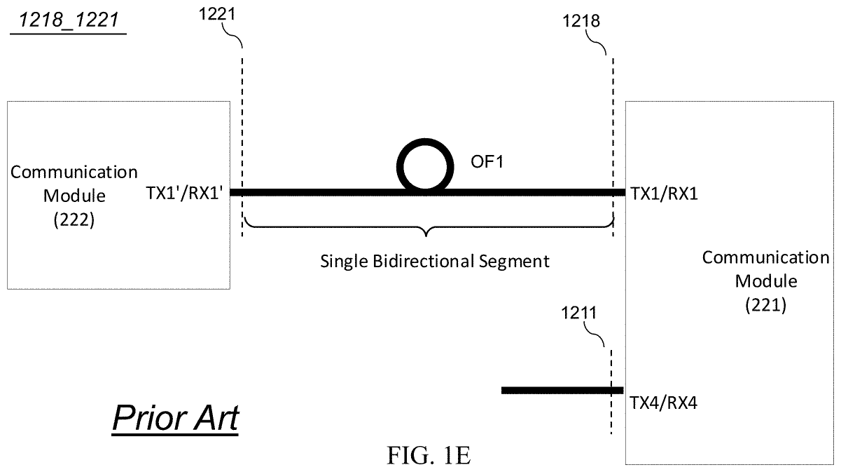

The present disclosure describes various implementations of an (optical) communication module with integrated OTDR capability that can participate in data communication over a fiber optic network without affecting data communication and/or possible upgrade paths of the data communication links and/or modules. For the sake of description of the various embodiments of the present disclosure, an exemplary network configuration as depicted in FIG. 1A is considered. A person skilled in the art would clearly understand that the teachings according to the present disclosure are not limited to such exemplary configuration.

With reference to FIG. 1A, an exemplary block diagram of a fiber optic network (100) is shown, wherein optical fibers, shown in dotted lines, form fiber optic links between ports of the network (100). In the exemplary configuration depicted in FIG. 1A, a plurality of links connect ports of network components (110, 121, 122, 123, 125, 126, 127, 128), wherein, for example, component (110) may be a server, components (121, 122, 123) may be routers or switches, and components (125, 126, 127, 128) may be workstations. As can be seen in FIG. 1A, components (121, 122, 123) may communicate via interconnecting fiber optic links connected to respective ports of such components. For example, port (1218) of network component (121) is linked to port (1221) of network component (122) via a fiber optic link (1218_1221). Similarly, port (1211) of network component (121) is linked to port (1231) of network component (123) via a fiber optic link (1211_1231). As used herein, the term “port” may refer to a physical port of a network component (e.g., 121, 122, 123, etc.), used to physically connect an optical fiber and thereby forming a fiber optic link. A person skilled in the art would know of many different types and configurations of such port, description of which is beyond the scope of the present disclosure. As it well known in the art, such port may be externally accessible to facilitate quick connection/disconnection of the optical fiber or may be an internal port that may not be easily/readily accessible.

As it is well known in the art, each network component (e.g., 121, 122, 123) can include one or more ports, each such port capable of transmitting, receiving, or transmitting and receiving (bidirectional) data over the fiber optic links. As is well known to a person skilled in the art, such ports may each include a communication module, such as a transmitter (module), a receiver (module), or a transmitter and receiver (module), for communication over a fiber optic link. Some exemplary port configurations are shown in FIG. 1B, FIG. 1C, FIG. 1D and FIG. 1E.

FIG. 1B shows some details of one possible configuration of a fiber optic link between ports of the network (100), exemplified by the fiber optic link (1218_1221) between port (1218) of network component (121) and port (1221) of network component (122). As can be seen in the configuration of FIG. 1B, the port (1218) is configured to receive data over the fiber optic link (1218_1221) via a receiver RX1 (i.e., receiver module 221) and the port (1221) is configured to transmit data over the fiber optic link (1218_1221) via a transmitter TX1′ (i.e., transmitter module 222). In the exemplary configuration shown in FIG. 1B, a link between the two ports is provided by a single optical fiber OF1 (e.g., single strand) that is coupled, at respective ends of the optical fiber OF1, to the receiver RX1 (221) and the transmitter TX1′ (222). Accordingly, the optical fiber OF1 shown in FIG. 1B may form a single segment, or in other words, there may be no discontinuity in the optical fiber that forms a link between ports (1218) and (1221). A discontinuity, as defined in the present disclosure, may comprise any aspect of a fiber optic link that is not a single piece of uninterrupted optical fiber presenting a homogeneous light transmission property (optical signal path). Examples of discontinuities may be connectors, couplers, breaks, and inconsistencies in the optical fiber, such as, for example, slices and fusions. Discontinuities in the optical fiber may cause a unique signature based on measured light reflection. However, a given component in two different fiber optic links may not always have a same signature. Some discontinuities may be represented by peaks in (light) power, while others may be represented by dips. Discontinuities may also block light, transmit light, or do a combination of both, further complicating the analysis of discontinuities.

FIG. 1C shows another exemplary configuration of the fiber optic link (1218_1221), similar to the configuration described above with reference to FIG. 1B, wherein a link between the two ports (1218) and (1221) may include a discontinuity provided by two optical fibers (OF1, OF3). A person skilled in the art is well aware that such discontinuity may be in the form of connectors and/or couplers used, for example, to physically lengthen an optical signal path of a fiber optic link between two ports as shown in FIG. 1C. In the exemplary fiber optic link shown in FIG. 1C, the transmitter TX1′ (222) of port (1221) may transmit data to the receiver RX1 (221) of port (1218) via a first (single strand) optical fiber, OF1, that is coupled, via a connector (145), to a second (single strand) optical fiber, OF3. It should be noted that although the exemplary connector (145) is shown as a means to lengthen an optical signal path of the fiber optic link between ports (1221, 1218), other types of connectors may be envisioned, such as, for example, T-type connectors, that may allow tapping (e.g., eavesdropping) into the fiber optic link. As will be described later in the present disclosure, any such connector that creates a discontinuity in the optical fibers between respective ports, can affect quality of an optical signal received by the receiver RX1 (221). As will be described later in the present disclosure, the teachings according to the present disclosure can detect effects of such discontinuity via OTDR capability that may be integrated in the communication module.

FIG. 1D shows another exemplary configuration of the fiber optic link (1218_1221) between the ports (1218) and (1221) of the fiber optic network of FIG. 1A for bidirectional communication. As can be seen in the configuration of FIG. 1D, the port (1218) is configured to receive data over the fiber optic link (1218_1221) via a receiver RX1 (221r) and transmit data over the fiber optic link (1218_1221) via a transmitter TX1 (221r). Similarly, the port (1221) is configured to transmit data over the fiber optic link (1218_1221) via a transmitter TX1′ (222t) and receive data over the fiber optic link (1218_1221) via a receiver RX1′ (222r). Accordingly, each of the ports (1218) and (1221) are configured to transmit and to receive data over the fiber optic link (1218_1221) via respective communication modules (221) and (222). In the exemplary non-limiting configuration of FIG. 1D, the fiber optic link (1218_221) includes two optical fiber segments (OF1, OF3) between the transmitter TX1′ (222t) and the receiver RX (221r), and a single optical fiber segment (OF2) between the transmitter TX1 (221t) and the receiver RX′ (222r).

As it is well known in the art, a bidirectional communication module may be provided by separate optical signal paths, such as (OF1, OF3) and OF2 per the configuration shown in FIG. 1D, or can be provided, as shown in FIG. 1E, via a single optical signal path provided by one (or more) optical fiber segment (OF1). As known to a person skilled in the art, bidirectionality of the communication module over a single optical signal path may be provided by, for example, multiplexing of a transmit and a receive signal over the single optical signal path, or by using different optical signal wavelengths for each of the transmit and receive signals that can coexist over the single optical signal path. As will be described later, teachings according to the present disclosure may apply to any communication module, including a module that communicates via the bidirectional link shown in FIG. 1E.

As shown in FIG. 1D, the communication module (221) at port (1218) of the network component (121), and the communication module (222) at port (1221) of the network component (122) may each be a single channel communication, or stated in other words, adapted for communication over a single fiber optic link (1218_1221). On the other hand, as shown, for example in FIG. 1E, a communication module (221) that participates in a fiber optic link (e.g., 1218_1221) may be a multichannel (e.g., four channels) communication module for communication over a plurality of fiber optic links (e.g., links 1211_1231 and 1218_1221) of FIG. 1A). As it is well known in the art, a communication module (e.g., 221, 222) translates an electrical signal corresponding to data communicated over a wire link (e.g., copper) to an optical signal corresponding to same data for communication over an optical fiber link.

As it is well known in the art, each port of the fiber optic network (100) can be uniquely identified by a corresponding communication module and/or communication module channel. For example, with reference to the configuration of FIG. 1B where single channel communication modules (221, 222) are used, port (1218) can be uniquely identified by a single receive channel (RX1) of the communication module (221), and port (1221) can be uniquely identified by a single transmit channel (TX1′) of the communication module (222). In other words, the status (or operating conditions) of the fiber optic link (1218_1221) shown in FIG. 1B can be defined by the status of the single receive channel of the communication module (221), the single transmit channel of the communication module (222), as well as condition/connections of the optical fiber OF1. On the other hand, with reference to the configuration of FIG. 1D, the status of the fiber optic link (1218_1221) may be defined by the status of the single receive and transmit channel (RX1, TX1) of the communication module (221), the single receive and transmit channel (RX1′, TX1′) of the communication module (222), as well as condition/connections of the optical fibers OF1, OF2 and OF3.

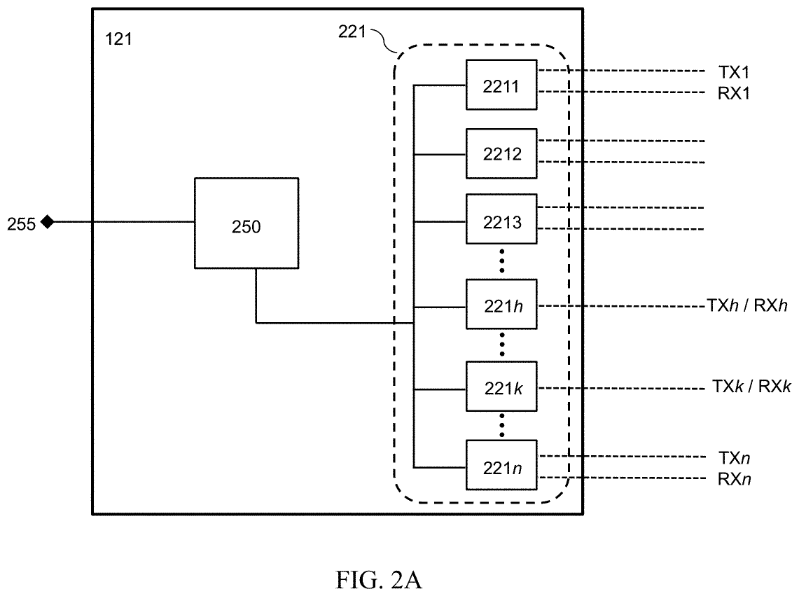

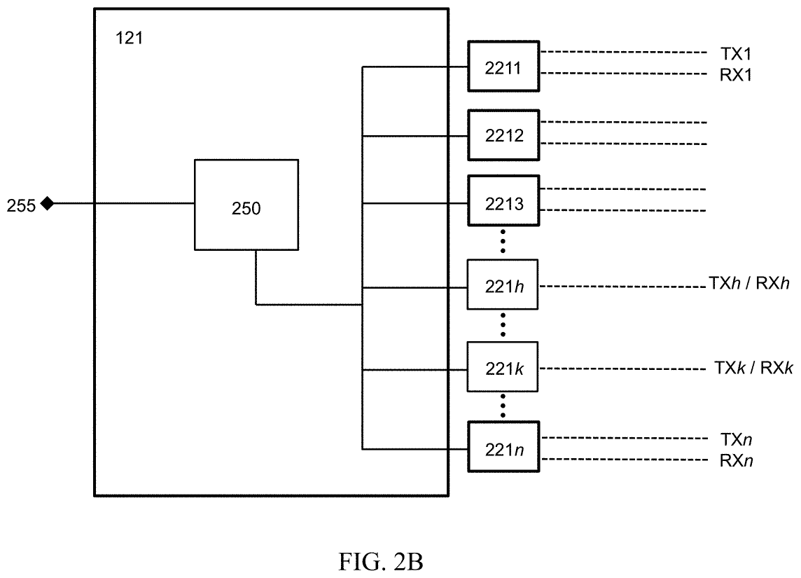

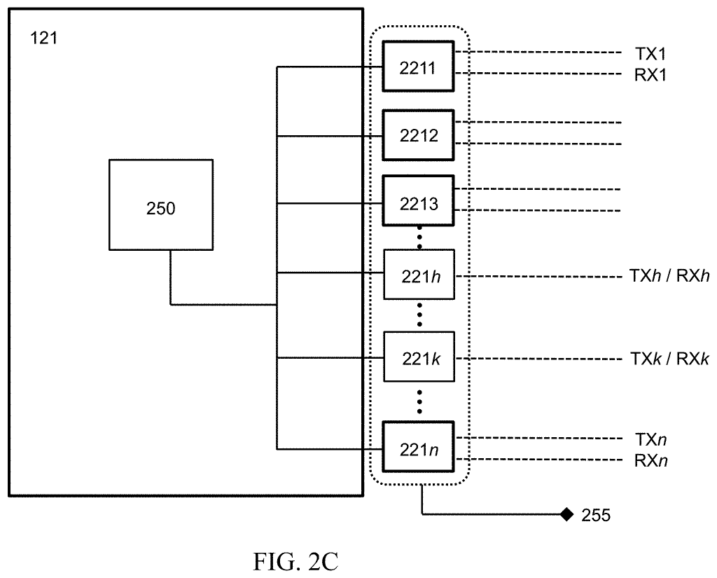

FIG. 2A shows an exemplary simplified block diagram of the network component (121) of the fiber optic network (100) of FIG. 1A. As shown in FIG. 2A, the network component (121) may include an embedded communication module (221), wherein a status of the communication module (221) may be available via a connection (255) to the network component (121). According to an exemplary embodiment, a controller unit (e.g., microprocessor, microcontroller) (250) of the network component (121) may communicate with the communication module (221) to read the status from the communication module (221) and make status data available via the connection (255). It should be noted that the connection (255) may be supported by any physical (hardware) and logical (software) data/communication interface and is not limited to any particular physical interface (wiring, connector, etc.) or logical data/communication interface (e.g., data/packet formats). For example, the connection (255) may be an ethernet port, a serial port, a parallel port, or any other standard or proprietary port of the network component (121) that is adapted for data communication, including a port of the fiber optic network (100) defined by any channel of the communication module (221). As shown in the exemplary embodiment of FIG. 2A, the communication module (221) may include one or more separate single channel communication modules (2211, . . . , 221n) each defining a different port of the network component (121). For example, each such single channel communication module (2211, . . . , 221n) may be: a receive or transmit module (e.g., 221h, 221k) for transmitting or receiving data over a single optical signal path (e.g., per FIG. 1B); a bidirectional module (e.g., 2211, 221n) for transmitting and receiving of data over different optical signal paths (e.g., per FIG. 1D); or a bidirectional module (e.g., 221h, 221k) for transmitting and receiving of data over a same optical signal path (e.g., per FIG. 1E).

As shown in FIG. 2B, according to some embodiments, the communication module of the network component (121) may not be embedded, but rather may be external to the network component (121). For example, as shown in the exemplary embodiment of FIG. 2B, the communication module may include a plurality of separate single channel (transmit and/or receive) communication modules (2211, . . . , 221n) each defining a different port of the network component (121). For example, each such single channel communication module (2211, . . . , 221n) may be a well-known in the art small form-factor pluggable (SFP or Quad-SFP) module that plugs to communication ports of the network component (121). According to one exemplary embodiment, when plugged to the network component (121) as shown in FIG. 2B, the controller unit (250) may communicate with each of the single channel communication modules (2211, . . . , 221n) to read status data from the communication modules (2211, . . . , 221n) and make such data available via the connection (255). Alternatively, or in addition, as shown in FIG. 2C, the connection (255) may directly interface with each of the single channel communication modules (2211, . . . , 221n). A person skilled in the art is well aware that a communication module, such as each of the single channel communication modules (2211, . . . , 221n), may include a controller (e.g., microprocessor, not shown in the figure) that can read and report via, for example, a dedicated interface, status data of the communication module. Furthermore, as described above with reference to FIG. 2A, the connection (255) may be any port of the fiber optic network (100) defined by any of the single channel communication modules (221, . . . , 221n).

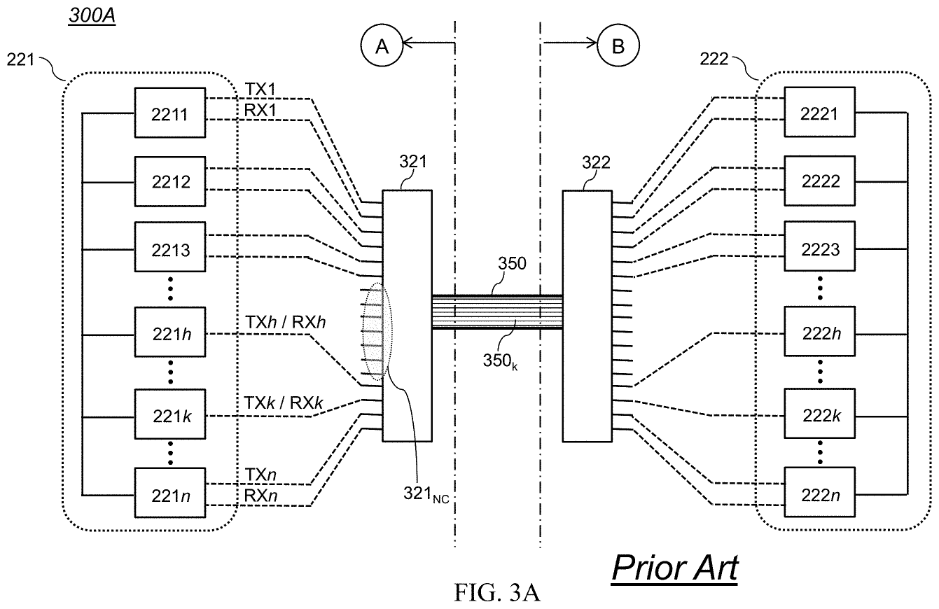

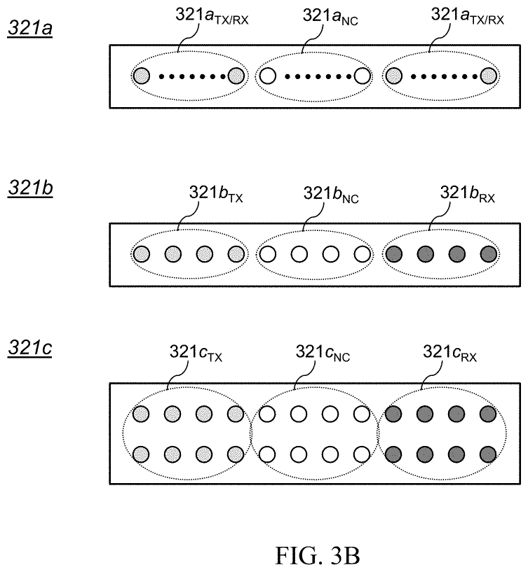

FIG. 3A shows a simplified block diagram (300A) of an exemplary connection between two communication modules (221, 222) of the exemplary fiber optic network of FIG. 1A via respective multi-fiber connectors (321, 322). As it is well understood by a person skilled in the art, each of the (optical) ports (2211, . . . , 221n) of the communication module (221) may be coupled via a respective optical link (showed in the figure as dotted lines) to the multi-fiber connector (321), and each of the ports (2221, . . . , 222n) of the communication module (222) may be coupled via a respective optical link to the multi-fiber connector (322). In turn, an optical fiber cable (350) that includes a plurality of optical fibers (350ₖ) may extend across two separate/distant locations A and B, to provide optical coupling between the two communication modules (221, 222) through the respective multi-fiber connectors (321, 322).

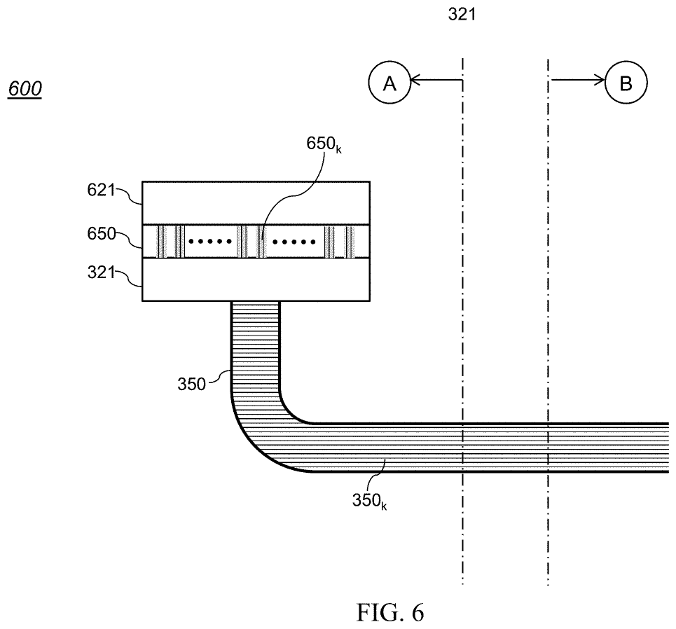

With continued reference to FIG. 3A, the optical links between the communication modules (221, 222) and the respective multi-fiber connectors (321, 322) may be individual optical fibers, each such optical fiber optically coupling a port of the communication modules (221, 222) to a respective port of the multi-fiber connectors (321, 322). Such configuration may be suitable, for example, in relatively large rack mounted network components (e.g., 121, 122 of FIG. 1A) with integrated or swappable communication modules (e.g., 221, 222). Other known in the art configurations may include chip-size integrated modules (e.g., foot print of 10 mm×10 mm or smaller) which are coupled to respective multi-fiber connectors via respective optical guide modules in a stacked configuration as shown in FIG. 6 later described. It should be noted that teachings according to the present disclosure equally apply to both such configurations.

FIG. 3B shows optical ports assignments for three exemplary multi-fiber connectors (321a), (321b) and (321c) that may be used in the configuration described above with reference to FIG. 3A. With reference to the multi-fiber connector (321a), one or more dedicated ports (321a_{TX/RX}) may be assigned for data communication (e.g., transmit TX, receive RX, or transmit and receive TX/RX) and therefore coupled to the ports of the communication modules (e.g., 221, 222 of FIG. 3A) that participate in the data communication over the fiber optic network (e.g., 100 of FIG. 1A). On the other hand, one or more dedicated ports (321a_{NC}) may be assigned as unused ports which are therefore not to be used for data communication, and therefore not coupled to any of the ports of the communication modules (e.g., 221, 222 of FIG. 3A). Although a physical layout and/or arrangement/sequence of the ports (321a_{TX/RX}) and (321a_{NC}) of a multi-fiber connector may be a design choice, some standard configurations used in the industry exist and are shown in the multi-fiber connectors (321b) and (321c). These correspond, for example, to well known in the industry a) single row quad (TX and RX) channel SFP interface port (321b) that includes four dedicated transmit ports (321b_{TX}), four dedicated receive ports (321b_{RX}), and four unused ports (321b_{NC}), and b) dual row eight (TX and RX) channel SFP interface port (321c) that includes eight dedicated transmit ports (321c_{TX}), eight dedicated receive ports (321c_{RX}), and eight unused ports (321c_{NC}). It should be noted that such multi-fiber connectors may be provided pre-assembled with a connector housing and a patchcord that can be used to fixate an optical fiber cable (e.g., 350 of FIG. 3A).

With continued reference to FIG. 3A, irrespective of their assignment as participating or unused, ports of the connector (321), such as (321a_{TX/RX}) and (321a_{NC}) of the multi-fiber connector (321a), may be coupled to optical fibers (e.g., 350ₖ of FIG. 3A) of an optical fiber cable (e.g., 350 of FIG. 3A). Accordingly, when used in a fiber optic network such as one shown in FIG. 1A to provide data communication links between network components at separate/distant locations (e.g., per FIG. 3A), the combination of the multi-fiber connector (321a) and a corresponding optical fiber cable (e.g., 350 of FIG. 3A), provides an equivalent/same physical routing of each optical fiber (e.g., 350ₖ of FIG. 3A) of the optical fiber cable coupled to the participating or unused ports (321a_{TX/RX}) and (321a_{NC}) of the multi-fiber connector (321a). Teachings according to the present disclosure take advantage of such routing to infer potential issues with the data communication links based on OTDR measurements of an optical fiber coupled to an unused port (321a_{NC}) of the multi-fiber connector (321a). Because the unused port (321a_{NC}) does not participate to the data communication, the OTDR measurement can be considered as “transparent” to the data communication. In other words, data communication, and/or any upgrades related to the data communication, can be performed independently from the OTDR. This independence may translate, for example, to different or same types/modes of optical fibers used for the data communication and the OTDR measurement. For example, data communication may use any one of a single-mode or multi-mode optical fibers known to a person skilled in the art, and the OTDR measurement may also use any one of the single-mode or multi-mode fibers independently from the data communication.

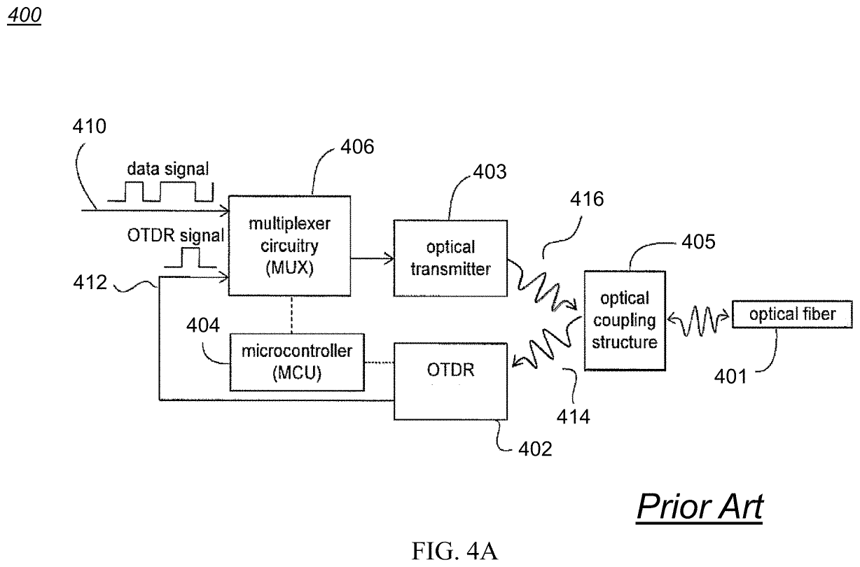

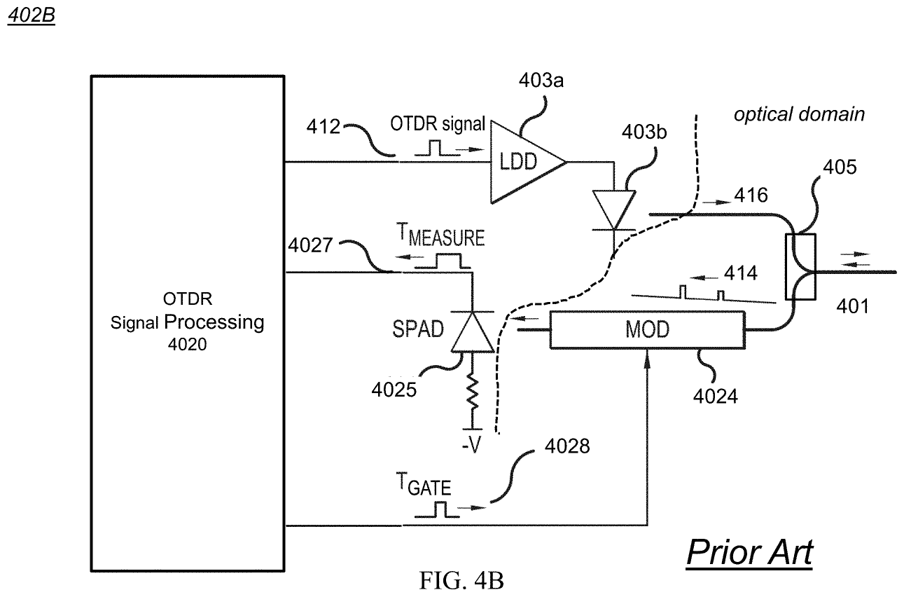

FIG. 4A shows a simplified block diagram of a transmitter module (400) with an integrated OTDR (402) that can be integrated in a chip, such as, for example, an ASIC (application-specific integrated circuit). Such transmitter module (400) may be used as a transmitter module at any port (e.g., 121, 1218, 1221, etc.) of the fiber optic links (e.g., 1218_1221) of the fiber optic network (100).

As can be seen in FIG. 4A, the transmitter module (400) includes a multiplexer circuitry (MUX, 406), and optical transmitter (403), and OTDR (402), a processor or microcontroller (MCU, 404) and an optical coupling structure (405) that is configured to be coupled to an optical fiber (401) uses in a fiber optic link. The microcontroller (404) may control operation of the transmitter module (400) according to a data transmission mode for transmitting of data signal (410) through the optical fiber (401), or according to an OTDR mode for obtaining an OTDR measurement of the optical fiber (401) using an OTDR signal (e.g., pulse signal) transmitted to (and reflected from) the optical fiber (401). OTDR measurement data can be stored in memory (not shown) or otherwise communicated to the outside of the transmitter module via a communications link (e.g., connection 255 of FIGS. 2A-2C).

With continued reference to FIG. 4A, during operation in the data transmission mode, the microcontroller (404) controls the multiplexer (406) to pass the data signal (410) to the optical transmitter (403), the optical transmitter (403) converts the data signal (410) to a light signal (416), and the optical coupling structure (405) couples the light signal (416) into the optical fiber (401). During operation in the OTDR measurement mode, the microcontroller (404) controls the multiplexer (406) to pass the OTDR signal (412) to the optical transmitter (403), the optical transmitter (403) converts the OTDR signal (412) to a light signal (416), and the optical coupling structure (405) couples the light signal (416) into the optical fiber (401).

With continued reference to FIG. 4A, some of the light signal (416) may reflect back from the optical fiber (401) and be directed, by the optical coupling structurer (405), to the OTDR (402) as a reflected light signal (414) for processing. As known to a person skilled in the art, such reflected light signal (414) may be due, for example, to an optical discontinuity or disruption in an optical signal path provided by the optical fiber (401). By measuring a time between the emitted light signal (416) (or corresponding electrical signal 412) and the received (reflected) light signal (414) (or corresponding electrical signal) in the OTDR (402), a position of a discontinuity (disruption) in the optical fiber (401) can be calculated. More description and implementation details of the transmitter module (400) can be found, for example, in the above referenced U.S. Pat. No. 8,854,609, the disclosure of which is incorporated herein by reference in its entirety.

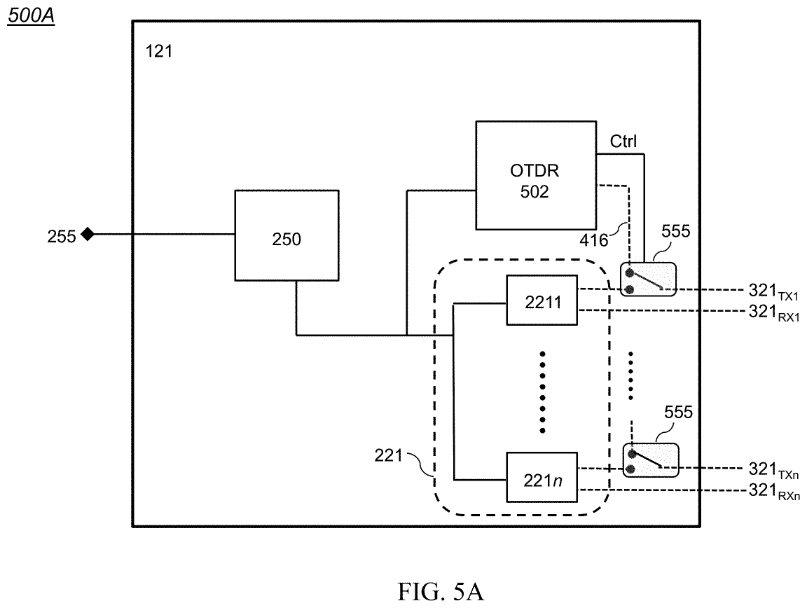

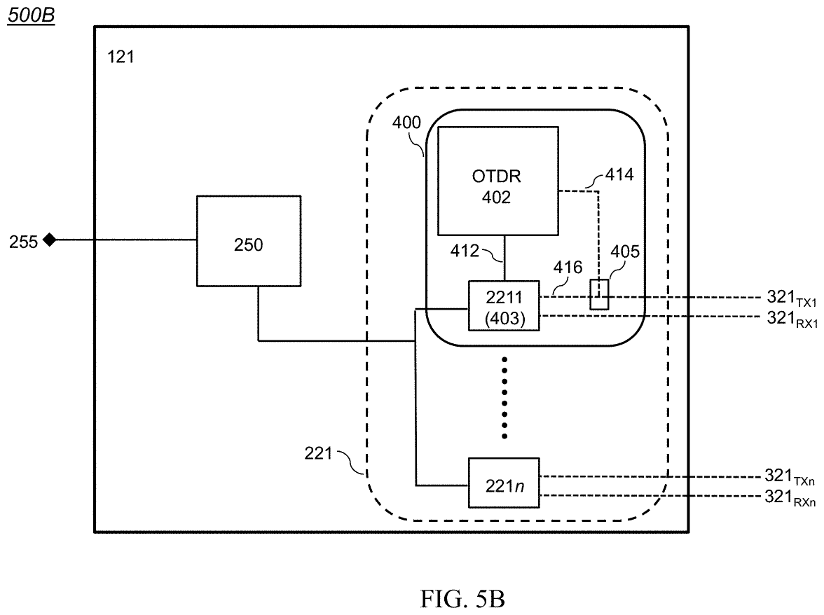

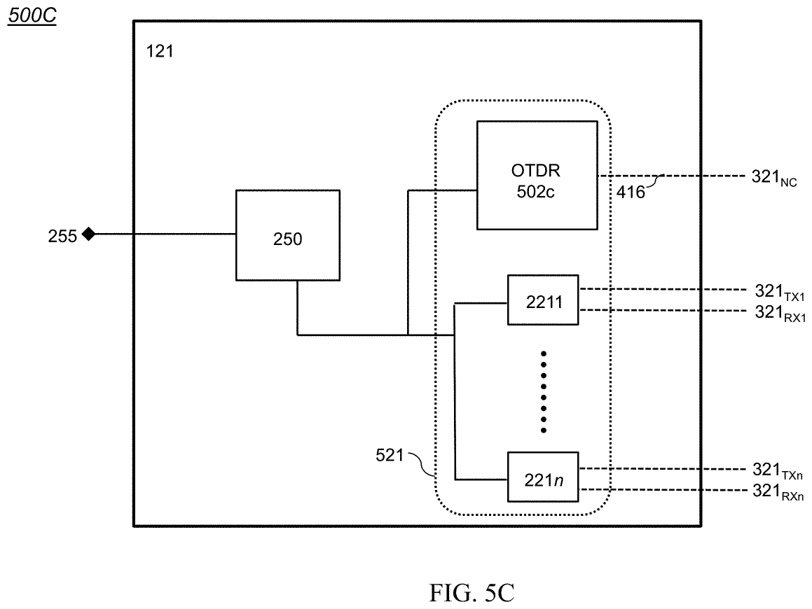

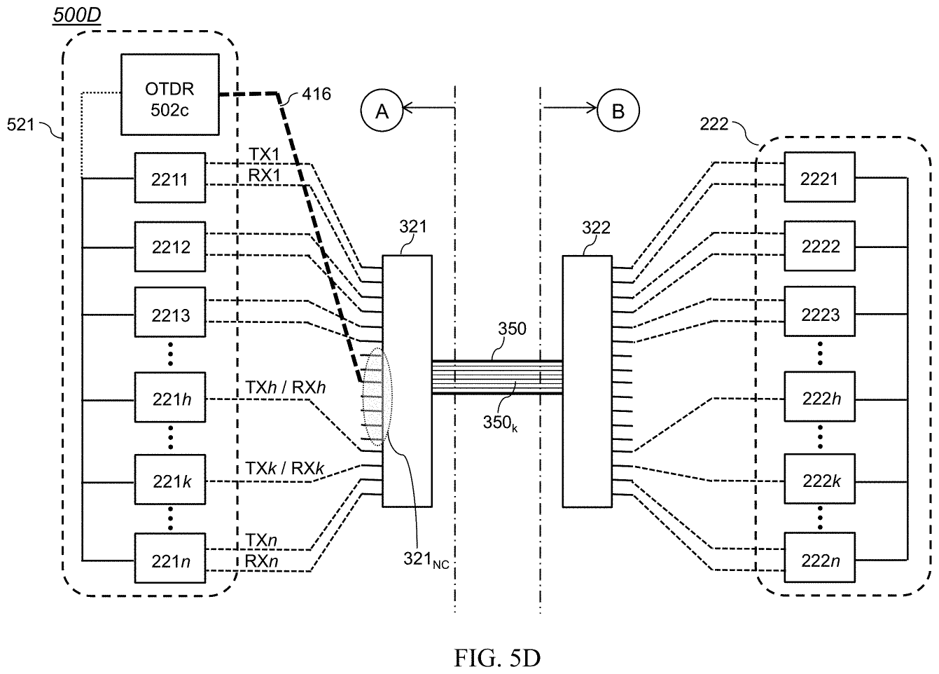

FIG. 4B shows a simplified schematic of an exemplary implementation of an OTDR (402B) which can be used, for example, as the OTDR (402) of FIG. 4A. As can be seen in FIG. 4B, the OTDR Signal Processing block (4020) generates a reference electrical OTDR signal (e.g., pulse 412) that is driven by a driver (403a) to excite a light source (403b) and thereby generate a corresponding light OTDR signal (416) that is transmitted through an optical fiber (401), wherein the combination of the driver (403a) and the light source (403b) can be likened to the optical transmitter (403) of FIG. 4A. Reflected light (414), including light pulses, by the optical fiber (401) may be fed to a (high-speed) modulator (4024) that is placed in a path of the reflected light (414) and in front of a photo-sensor (4025). A gating signal (4028) can drive the modulator (4024) so to block out reflected light except during a measuring time defined by a pulse length of the gating signal (4028). Accordingly, a sampled reflected electrical signal (4027) is generated by the photo-sensor (4025) and transmitted to signal processing electronics (4020) of the OTDR for further processing. Usage of the modulator (4024) to gate the reflected light may be considered advantageous in providing an increase in dynamic range and sensitivity of the OTDR measurement while maintaining relatively high measurement throughputs. Other OTDR implementations known to a person skilled in the art which can be used as an integrated circuit are fully compatible for integration according to the present teachings. It should be noted that such OTDR may be fully integrated within a transmitter module as described with reference to FIG. 4A and as shown in FIG. 5A later described, or can be selectively coupled to an optical fiber that is part of a fiber optic link by selectively coupling to said fiber either an optical (light) transmit data signal or an optical (light) OTDR signal as shown in FIG. 5B later described. Teachings according to the preset disclosure couple the OTDR signal to an unused port of a multi-fiber connector, and therefore allow for transparent operation of the OTDR with respect to the data communication.

It should be noted that a person skilled in the art would know of methods and systems other than the OTDR shown in FIG. 4A and FIG. 4B for measuring characteristics of an optical fiber based on a corresponding reflected light. According to one exemplary implementation, OTDR may be based on a light wavelength that is different from a light wavelength used for data communication in a link of the fiber optic network, and therefore a corresponding OTDR measurement of the link may be performed during data communication through the link. According to another exemplary implementation, OTDR measurement can be based on (back) reflected signal power/light of data (traffic) being communicated through a link in combination with correlation techniques that take into consideration (light) patterns generated by the data traffic. Other well known in the art techniques may include OFDR (optical frequency domain reflectometry) where signal generation and analysis are performed in frequency domain, such as, for example, interferometric technique with a swept laser wavelength or with a swept frequency electrical tone signal.

FIG. 5A shows a simplified block diagram (500A) of a network component (121) of the fiber optic network (100) of FIG. 1A, such as the network component of FIGS. 2A and 2B, comprising an integrated OTDR (502) such as, for example, the OTDR (402B) of FIG. 4B. As shown in the exemplary configuration of FIG. 5A, the OTDR (502) may be selectively coupled to a transmit side ports (e.g., 321_{TX1}, 321_{TXn}) of a multi-fiber connector (e.g., 321 of FIG. 3A). In the exemplary configuration depicted in FIG. 5A, an optical switch element (555) may be used to selectively couple a reference light pulse (416) from the OTDR (502) and an output light signal from a transmit channel of the communication module (221) to a fiber optic used in a corresponding fiber optic link. In other words, in the configuration shown in FIG. 5A, the OTDR signal shares a same optical fiber used for data communication. A person skilled in the art will know of many exemplary implementations of the optical switch element (555), which may include, for example, optical lenses/mirrors, beam combiner, or beam splitters. It should be noted that in view of typical usage of semiconductor-based light elements (e.g., laser diodes) as light sources in the transmitter of a communication module as well as in the OTDR (502), switching of the light via direct control of such light elements may also be provided, in combination with other optical elements to provide functionality of the optical switch element (555).

With continued reference to FIG. 5A, start of an OTDR measurement cycle may be triggered by the controller (250), under for example, a request/command issued through the connection (255), which in turn may prompt the OTDR (502) to switch state of the switch (555) (e.g., via a control flag Ctrl) and couple the reference light pulse (416) to the fiber optic. Alternatively, or additionally, a local controller to the communication module or to the OTDR (502) may start an OTDR measurement cycle and store corresponding measurement in local memory for later reporting. It should be noted that although the configuration depicted in FIG. 5A shows a single OTDR (502) that can be multiplexed amongst various fiber optic links provided by communication channels (2211, . . . , 221n) of the network element (121), according to other implementations, more than one OTDR (502) can be used, so that, for example, each port (2211, . . . , 221n) comprises a respective OTDR (502). Such one-to-one configuration between a communication channel and a corresponding OTDR (410) may be used, for example, in configurations where the communication modules are external to the network element (121), such as, for example, described above with reference to FIGS. 2B and 2C. Such configurations may advantageously use transmitter modules with integrated OTDR as described above with reference to FIG. 4A and shown (e.g., item 400) in the simplified block diagram of FIG. 5B. In some cases, it may be desired to decouple the OTDR measurement from data communication links, as shown in FIG. 5C.

FIG. 5C shows a simplified block diagram according to an embodiment of the present disclosure of a network component (121) of the fiber optic network of FIG. 1A, such as the network component of FIGS. 2A and 2B, comprising an OTDR (502c) integrated with a communication module (521) but transparent to communication data communicated via receive and/or transmit links of the network component (121). As shown in FIG. 5C, the OTDR signal (e.g. 416) is coupled to an unused port (321_{NC}) of a multi-fiber connector (e.g., 321 of FIG. 5D) used in the data communication. It should be noted that the OTDR (502c) may be according to the exemplary configuration described above with reference to FIG. 4B, or any other configuration known to a person skilled in the art that can be integrated in the communication module (521), whether as a component in a pluggable system (e.g., multiple individual modules) or as a component in an integrated chip-size module (e.g., single combined module).

With continued reference to FIG. 5C, control of the OTDR (502c) may be based on the controller unit (250) that is used to control the entire communication module (521), or can be based on a separate and dedicated controller that is separate from the controller unit (250) (not shown in the figure). Furthermore, because the OTDR (502c) operates over the unused ports of the multi-fiber connector (321), operation of the OTDR can be transparent from the data communication. Such configuration may allow for a more cost effective solution for OTDR integration in a fiber optic network as a corresponding OTDR channel/link may not be subject to same optimization requirements as the data/channel links, including when upgrading data communication schemes and/or speeds.

FIG. 5D shows a simplified block diagram (500D) of a connection according to an embodiment of the present disclosure between two communication modules (521, 222) of the exemplary fiber optic network of FIG. 1A via respective multi-fiber connectors (321, 322). In particular, FIG. 5D shows connection of the communication module (521) described above with reference to FIG. 5C, positioned at a location A, to the communication module (222) positioned at a separate/distance location B, via similar elements/component described above with reference to FIG. 3A. As can be clearly seen in FIG. 5D, optical coupling between the OTDR (502c) and the optical fiber cable (350) is via an unused port (321_{NC}) of the multi-fiber connector (321).

With continued reference to FIG. 5D, according to an embodiment of the present disclosure, a link fault detected by the OTDR (502c) over an optical channel (link) provided/dedicated to the OTDR signal (416) between the OTDR (502c) positioned at the location A, and the multi-fiber connector positioned at the location B, can be used as indication of a possible fault in the data communication links between communication modules (521) and (222). As clearly understood by a person skilled in the art, the optical channel of the OTDR (502c) passes through the unused port (321_{NC}) of the multi-fiber connector (321), whereas optical channels of the data communication links pass through the transmit (e.g., 321_{TX}) and/or receive (e.g., 321_{TX}) ports of the of the multi-fiber connector (321). In other words, because an optical path of the OTDR follows the optical paths used for the data communication, a fault detected (via OTDR) in the optical path of the OTDR may be used an indication of a (possible) fault in the optical paths of the data communication. Such fault detected by the OTDR (502c) may be, for example, in view of a cut or a splice in the optical fiber cable (350) or any unexpected disconnected elements that form, or support the formation, of the optical channel of the OTDR (502c). It should be noted that the communication module (521) may include one or more transmitter modules and/or one or more receiver modules, and therefore need not necessarily include a combination of transmitter and modules. Furthermore, although not shown in FIG. 5D, a similar OTDR may be integrated in the communication module (222) and coupled to an unused port of the multi-fiber connector (322) that is not coupled to the same unused port of the multi-fiber connector (321) used for the OTDR (502c) shown in FIG. 5D.

As described above with reference to FIG. 3A, the optical links between the communication modules (521, 222) and the respective multi-fiber connectors (321, 322) shown in FIG. 5D may be individual optical fibers, each such optical fiber optically coupling a port of the communication modules (521, 222), including a port (e.g., for routing of signal 416) used for the OTDR (502c), to a respective port of the multi-fiber connectors (321, 322). Such configuration may be suitable, for example, in relatively large rack mounted network components (e.g., 121, 122 of FIG. 1A) with integrated or (individually) swappable communication modules (e.g., 221, 222). Other known in the art configuration (600) is shown in FIG. 6, which may include a chip-size integrated module (621) which is coupled to a respective multi-fiber connector (321) via a respective optical guide module (650) in a stacked configuration.

With further reference to FIG. 6, the integrated module (621) may include all of the components shown in the communication module (521) of FIG. 5C. The optical guide module (650) may include optical guide channels (650ₖ) to optically couple ports of the communication module (521) to respective ports of the multi-fiber connector (321). A person skilled in the art is well aware of design and implementation techniques of such optical guide module (650), description of which is outside the scope of the present disclosure. In particular, embedded within a base substrate (also labelled as 650), the optical guide module (650) may include individual optical guide channels (650ₖ) of a known/controlled optical characteristic to conduct/guide optical signals coupled at one surface of the optical guide module (650) to another surface of the optical guide module (650). In the exemplary configuration shown in FIG. 6, such surfaces are parallel surfaces at opposite sides of the substrate (e.g., 650). Other configurations with non-parallel surfaces and/or curved or segmented optical guide channels (650ₖ) may also be envisioned per design goals and performances.

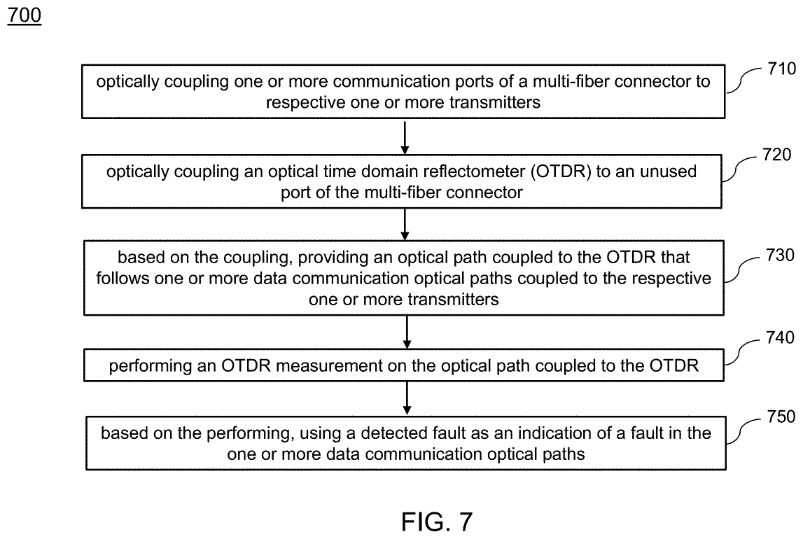

FIG. 7 is a process chart (800) showing various steps of a method for detecting a fault in a data communication optical path of a fiber optic network. As can be seen in FIG. 7, such steps comprise: optically coupling one or more communication ports of a multi-fiber connector to respective one or more transmitters, per step (710); optically coupling an optical time domain reflectometer (OTDR) to an unused port of the multi-fiber connector, per step (720); based on the coupling, providing an optical path coupled to the OTDR that follows one or more data communication optical paths coupled to the respective one or more transmitters, per step (730); performing an OTDR measurement on the optical path coupled to the OTDR, per step (740); and based on the performing, using a detected fault as an indication of a fault in the one or more data communication optical paths, per step (750).

Accordingly, in view of the above embodiments, methods and devices have been disclosed that enable optical data communication with integrated data-transparent OTDR that can be used in fiber optic communication systems.

It is understood that the specific order or hierarchy of steps in the processes disclosed is an example of applicable approaches. Based upon design preferences, the specific order or hierarchy of steps in the processes may be rearranged while remaining within the scope of the present disclosure. The accompanying method claims present elements of the various steps in a sample order and are not meant to be limited to the specific order or hierarchy presented.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium is coupled to the processor such that the processor can read information from, and write information to, the storage medium.

It will be understood that many additional changes in the details, materials, steps and arrangement of parts, which have been herein described and illustrated to explain the nature of the invention, may be made by those skilled in the art within the principle and scope of the invention as expressed in the appended claims.

1. An optical data communication arrangement, comprising:
a multi-fiber connector comprising at least one data communication port and at least one unused port that is separate from the data communication port;
at least one transmitter or receiver optically coupled to the at least one data communication port; and
an optical time domain reflectometer (OTDR) optically coupled to the at least one unused port,
wherein the at least one data communication port is a port of the multi-fiber connector that is dedicated for data communication, and the at least one unused port is a port of the multi-fiber connector that is dedicated for OTDR measurement.

2. The optical data communication arrangement according to claim 1, wherein
the at least one transmitter or receiver is optically coupled to the data communication port via a respective optical fiber, and
the OTDR is optically coupled to the unused port via a respective optical fiber.

3. The optical data communication arrangement according to claim 2, wherein
a type of the respective optical fiber that couples the at least one transmitter or receiver to the data communication port is:
one of a single-mode or multi-mode type, and
different from a type of the respective optical fiber that couples the OTDR to the unused port.

4. The optical data communication arrangement according to claim 2, wherein
a type of the respective optical fiber that couples the at least one transmitter or receiver to the data communication port is:
one of a single-mode or multi-mode type, and
same as a type of the respective optical fiber that couples the OTDR to the unused port.

5. The optical data communication arrangement according to claim 1, wherein
ports of the multi-fiber connector, including the at least one data communication port and the at least one unused port, are coupled to an optical fiber cable comprising a plurality of optical fibers.

6. The optical data communication arrangement according to claim 5, wherein
the optical fiber cable is configured to couple the at least one transmitter or receiver to components of a fiber optic network located at a different location via a data communication optical path formed in part by the optical fiber cable, and
the OTDR is configured to detect a fault in an optical path that is coupled to the OTDR and follows the data communication optical path.

7. The optical data communication arrangement according to claim 1, wherein
the optical data communication arrangement further comprises an optical guide module comprising a plurality of optical guide channels; and
the at least one transmitter or receiver and the OTDR are optically coupled to the multi-fiber connector via respective optical guide channels of the optical guide module.

8. The optical data communication arrangement according to claim 7, wherein
the at least one transmitter or receiver and the OTDR are integrated in a chip-size communication module, and
the chip-size communication module, the optical guide module and the multi-fiber connector are arranged in a stacked configuration.

9. The optical data communication arrangement according to claim 8, wherein
the chip-size communication module has a footprint of about 10 mm by 10 mm or less.

10. The optical data communication arrangement according to claim 8, wherein
the chip-size communication module comprises a plurality of transceivers or receivers optically coupled to the multi-fiber connector via respective optical guides of the optical guide module.

11. The optical data communication arrangement according to claim 10, wherein
the multi-fiber connector is according to one of: a) a single row quad channel small form factor interface port, or b) a dual row eight channel small form factor interface port.

12. The optical data communication arrangement according to claim 1, wherein
the multi-fiber connector is according to one of: a) a single row quad channel small form factor interface port, or b) a dual row eight channel small form factor interface port.

13. A fiber optic network comprising the optical data communication arrangement of claim 1.

14. The fiber optic network according to claim 13, wherein
the optical data communication arrangement is arranged in a rack of the fiber optic network, and
the at least one transmitter and the OTDR of the optical data communication arrangement are pluggable modules of the rack.

15. An optical data communication system, comprising:
a first multi-fiber connector comprising a plurality of data communication ports and at least one unused port that is separate from said data communication ports;
one or more transmitters optically coupled to respective one or more ports of the plurality of data communication ports of the first multi-fiber connector; and
an optical time domain reflectometer (OTDR) optically coupled to the at least one unused port of the first multi-fiber connector,
wherein the plurality of data communication ports are ports of the first multi-fiber connector that are dedicated for data communication, and the at least one unused port is a port of the first multi-fiber connector that is dedicated for OTDR measurement.

16. The optical data communication system according to claim 15, further comprising:
a second multi-fiber connector comprising a plurality of data communication ports and at least one unused port that is separate from said data communication ports;
an optical fiber cable comprising a plurality of optical fibers that optically couple the plurality of data communication ports and the at least one unused port of the first multi-fiber connector to the plurality of data communication ports and the at least one unused port of the second multi-fiber connector;
one or more receivers optically coupled to the plurality of data communication ports of the second multi-fiber connector for respective data communication with one or more transmitters.

17. The optical data communication system according to claim 16, wherein
each of the first and the second multi-fiber connector is according to one of: a) a single row quad channel small form factor (SFP) interface port, or b) a dual row eight channel SFP interface port.

18. The optical data communication system according to claim 16, wherein
the OTDR is configured to detect a fault in an optical path that is coupled to the OTDR and follows a data communication optical path between the one or more transmitters and the one or receivers.

19. A method for detecting a fault in a data communication optical path of a fiber optic network, the method comprising:
optically coupling one or more data communication ports of a multi-fiber connector to respective one or more transmitters;
optically coupling an optical time domain reflectometer (OTDR) to an unused port of the multi-fiber connector;
based on the coupling, providing an optical path coupled to the OTDR that follows one or more data communication optical paths coupled to the respective one or more transmitters;
performing an OTDR measurement on the optical path coupled to the OTDR; and
based on the performing, using a detected fault as an indication of a fault in the one or more data communication optical paths,
wherein the one or more data communication ports are ports of the multi-fiber connector that are dedicated for data communication, and the unused port is a port of the multi-fiber connector that is dedicated for the OTDR measurement.
